(19) United States
(12) Patent Application Publication
(10) Pub. No.: US 2005/0109530 A1
(43) Pub. Date: May 26, 2005

(54) Electric wire for vehicle

(75) Inventor: Koutarou Maeda, Yokkaichi-city (JP)

Correspondence Address: OLIFF & BERRIDGE, PLC, P.O. BOX 19928, ALEXANDRIA, VA, 22320, US

(73) Assignee: SUMITOMO WIRING SYSTEMS, LTD., Yokkaichi-city (JP)

(21) Appl. No.: 10/936,518

(22) Filed: Sep. 9, 2004

(30) Foreign Application Priority Data
Nov. 25, 2003 (JP) 2003-394523

(51) Int. Cl. H01B 5/08

(52) U.S. Cl. 174/128.1

(57) ABSTRACT

An electric wire for a vehicle is provided whose tensile strength can be adjusted to various degrees without having to change the area of an electric conductor to satisfy various tensile strength requirements. The electric wire for a vehicle includes an electric conductor composed of a single central wire made of stainless steel and seven or more peripheral wires, made of copper or copper alloy, that are disposed in one layer on the periphery of the central wire with the peripheral wires joining with each other such that the peripheral wires surround the central wire. The diameter of the central wire is set larger than that of the peripheral wires. The area ratio of the electric conductor satisfies the relation area ratio of electric conductor={(A+B)/C}×100(%)≧85(%) where A denotes a total of sectional areas of the peripheral wires, B denotes a sectional area of the central wire, and C is a sectional area of the electric conductor.

### CROSS-REFERENCE TO RELATED APPLICATION

The invention claims priority to Japanese Patent Application No. JP 2003-394523 filed on Nov. 25, 2003. The disclosure of the prior application is incorporated herein by reference in its entirety.

### BACKGROUND OF THE INVENTION

1. Field of Invention

The invention relates to an electric wire for use in a vehicle (hereinafter referred to as vehicle electric wire). Particularly, various exemplary embodiments of the invention relates to a vehicle electric wire whose tensile strength can be adjusted to various degrees without having to change the diameter of an electric conductor of the electric wire to satisfy various tensile strength requirements.

2. Description of Related Art

A wire harness including a large number of electric wires is used for electric connection of electric devices. The wire harness includes an electric conductor composed of a plurality of wires twisted together. FIG. 1 shows an electric conductor (aggregation of wires) 1 typical in this kind of electric wire. The electric conductor 1 shown in FIG. 1 has a stranded construction having a central wire 2 and one layer of six peripheral wires 3 arranged around the central wire 2, with peripheral wires 3 joining with each other. FIG. 2 shows an explanatory sectional view of the electrical conductor diameter.

In the conventional art, copper or copper alloy is commonly used for both the central wire 2 and the peripheral wire 3 constructing the electric conductor having the stranded construction. It is also common to use the central wire 2 and the peripheral wire 3 having a diameter equal to that of the central wire 2.

Requirements for electric wires are varied according to applications. There are demands for use of an electric wire having an ordinary tensile strength, an electric wire having a comparatively high tensile strength, an electric wire having a very high tensile strength. The electric conductor of the vehicle electric wire has a standard (for example, 0.13 mm², 0.22 mm²) for the diameter (size) thereof.

For an electric wire having a higher tensile strength, an electric wire whose electric conductor has a diameter larger by one or more ranks is used. However, the use of the electric wire whose electric conductor has a diameter larger by one or more ranks is negative toward the trend of using a vehicle electric wire which has a small diameter and is lightweight.

Such being the case, there is a demand for development of a vehicle electric wire whose tensile strength can be adjusted to various degrees without having to change the diameter of the electric conductor to satisfy various tensile strength requirements, namely, without using an electric wire whose electric conductor has a larger diameter.

### SUMMARY OF THE INVENTION

Various exemplary embodiments of the invention have been completed in view of the above-described situation. Therefore, it is an object of various exemplary embodiments of the invention to provide an electric wire for a vehicle whose tensile strength can be adjusted to various degrees without having to change the diameter of an electric conductor of the electric wire to satisfy various tensile strength requirements.

According to various exemplary embodiments of the invention, the above-described problems can be solved by the following technical means:
(1) An electric wire for a vehicle includes an electric conductor having a single central wire made of stainless steel and seven or more peripheral wires, made of copper or copper alloy, which are disposed in one layer on a periphery of the central wire with the peripheral wires joining with each other in such a way that the peripheral wires surround the central wire. A diameter of the central wire is set larger than that of the peripheral wires; and an area ratio of the electric conductor satisfies an equation: area ratio of electric conductor={(A+B)/C}×100(%)≧85(%), where A denotes a total of sectional areas of the peripheral wires, B denotes a sectional area of the central wire, and C is a sectional area of the electric conductor.
(2) An electric wire for a vehicle according to the above (1), wherein the area ratio of the electric conductor is not less than 90%.
(3) An electric wire for a vehicle according to the above (1) or (2), wherein the sectional area of the central wire is set to not less than 19.5% of the sectional area of the electric conductor.
(4) An electric wire for a vehicle according to anyone of the above (1) through (3), wherein the sectional area of the electric conductor is set to not more than 0.3 mm².
(5) An electric wire for a vehicle according to any one of the above (1) through (4), wherein the electric conductor is compressed.
(6) An electric wire for a vehicle according to any one of the above (1) through (5), wherein the electric conductor has a stranded construction.

According to various exemplary embodiments of the invention, because the above-described construction is adopted, it is possible to provide the electric wire for a vehicle whose tensile strength can be adjusted to various degrees without having to change the diameter of the electric conductor of the electric wire to satisfy various tensile strength requirements.

### BRIEF DESCRIPTION OF THE DRAWINGS

The accompanying drawings, which are incorporated into and constitute a part of the specification, illustrate one or more embodiments of the invention and, taken with the detailed description, serve to explain the principles and implementations of the invention.

In the drawings:

FIG. 1 is a sectional view showing an electric conductor of a vehicle electric wire having a conventional stranded construction (uncompressed electric conductor).

FIG. 2 is an explanatory sectional view showing the diameter of the electric conductor.

FIG. 3 is a sectional view showing an example of the construction of an electric conductor of a vehicle electric wire of various exemplary embodiments of the invention.

FIG. 4 is a sectional view showing an example of the construction of an electric conductor having seven peripheral wires.

FIG. 5 is an explanatory view for explaining parameters of the vehicle electric wire of various exemplary embodiments of the invention.

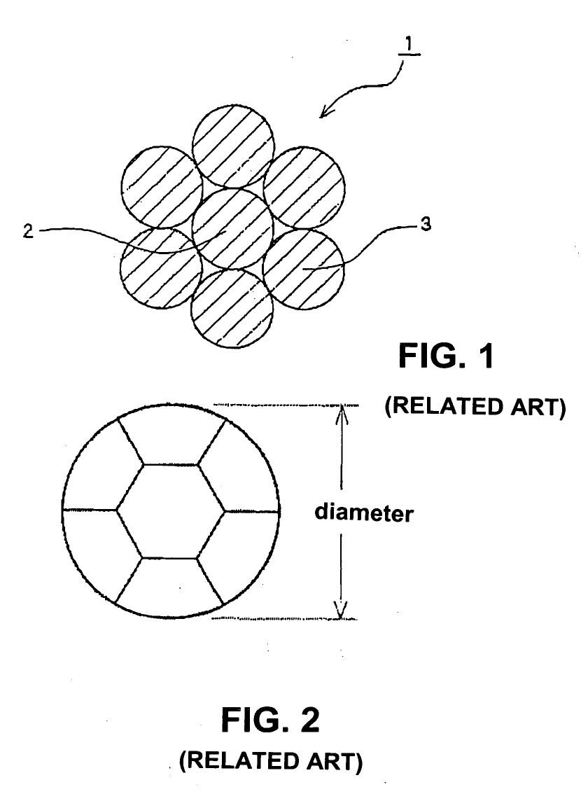

### DETAILED DESCRIPTION OF EXEMPLARY EMBODIMENTS

Preferred embodiments of the invention will be described below.

Various exemplary embodiments of the invention provide an electric wire for a vehicle including an electric conductor composed of a single central wire and seven or more peripheral wires disposed in one layer on the periphery of the central wire. The peripheral wires are joined to each other such that they surround the central wire. The central wire is made of stainless steel, while the peripheral wires are made of copper or copper alloy. The diameter of the central wire is set larger than that of the peripheral wires. The area ratio of the electric conductor is not less than 85% and favorably not less than 90%. The area ratio of the electric conductor is expressed by an equation shown below:
Area ratio of electric conductor={(A+B)/C}×100(%)≧85(%)
where A denotes a total of sectional areas of the peripheral wires, B denotes a sectional area of the central wire, and C is a sectional area of the electric conductor.

The sectional area C of the electric conductor is expressed by an equation as shown: C (mm²)=π×diameter (mm)×diameter(mm)÷4.

When the area ratio of the electric conductor of the vehicle electric wire for various exemplary embodiments of the invention is specified as above, depending on use, the tensile strength of the electric conductor can be increased, and the tensile strength can be adjusted to various degrees, depending on requirements. This is accomplished by appropriately selecting the relationship between the diameter of the central wire and that of the peripheral wire and selecting a desired number of the peripheral wires without changing the diameter of the electric conductor.

The electric conductor of the vehicle electric wire of various exemplary embodiments of the invention may be a compressed electric conductor or an uncompressed electric conductor, provided that the electric conductor satisfies the above-described condition.

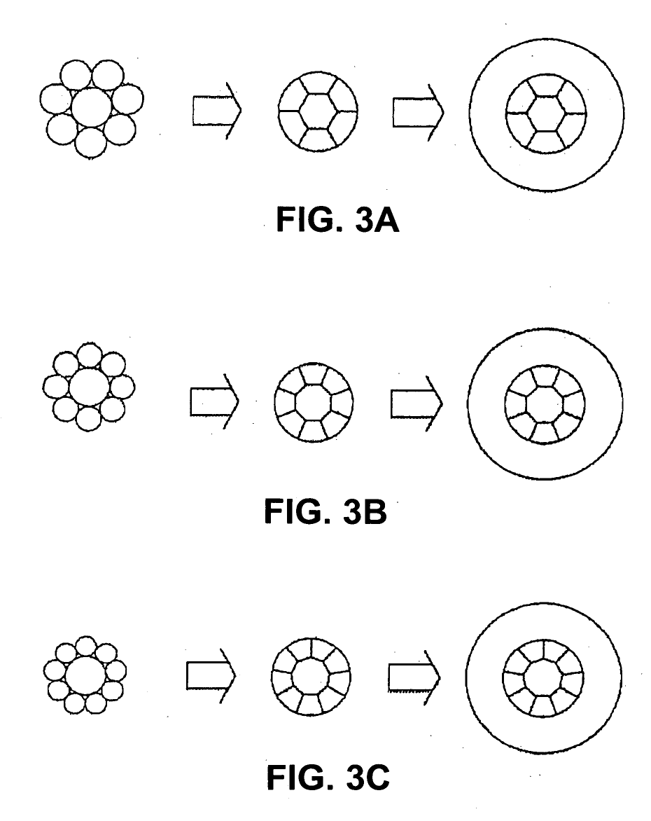

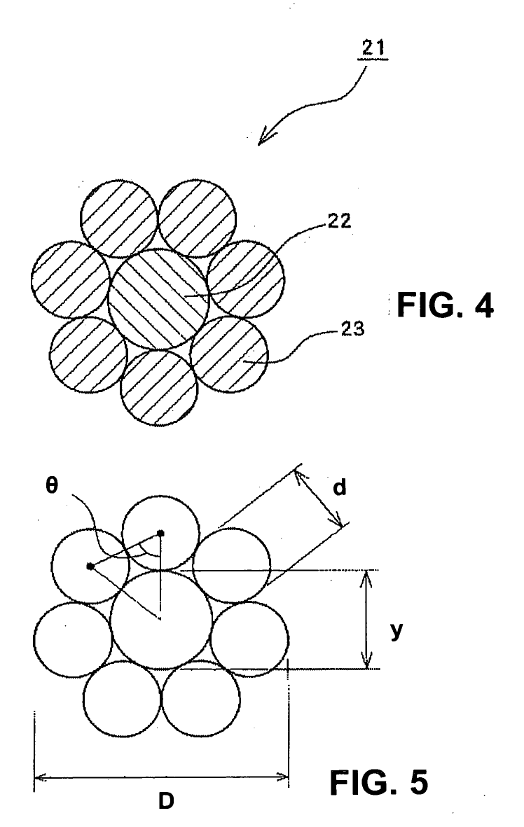

FIGS. 3A, 3B and 3C are sectional views showing one example of the construction of the compressed vehicle electric wire of various exemplary embodiments of the invention. FIGS. 3A, 3B, and 3C show the state of the electric conductor before it is compressed, after it is compressed, and after the electric conductor is coated with an insulating coating respectively. The number of the peripheral wires is seven, eight and nine in FIGS. 3A, 3B, and 3C respectively. FIG. 4 is a sectional view showing an electric conductor 21 having seven peripheral wires 22 before the electric conductor 21 is compressed.

In the electric conductor 21 which has not been compressed shown in FIG. 4, one layer of seven or more peripheral wires 23, made of copper or copper alloy, is disposed circumferentially on the periphery of a central wire 22 with the peripheral wires 23 joining with each other, and being twisted together to form the stranded construction. The diameter of the central wire 22 is set larger than that of the peripheral wire 23. The electric conductor having the central wire 22 and the peripheral wires 23 is compressed radially by using a compression die or the like to form a compressed electric conductor. An insulating coating is provided on the periphery of the compressed electric conductor directly or through a shielding layer to form the vehicle electric wire.

In setting the diameter of the central wire made of stainless steel larger than that of the peripheral wire made of copper or copper alloy, the diameter of the central wire can be variably set, depending on a demanded degree of tensile strength of the electric conductor. In various exemplary embodiments of the invention, the diameter of the central wire is set so that the sectional area of the central wire is set to not less than 19.5% of the sectional area of the entire electric conductor and preferably to the range of 19.5% to 29.1%. If the sectional area of the central wire is too small, it is difficult to increase the tensile strength of the electric conductor. If the sectional area of the central wire is too large, the electric resistance of the electric conductor becomes higher.

In the conventional vehicle electric wire described previously in the “Background Art”, six peripheral wires having a diameter equal to that of the central wire are disposed around the central wire in one layer with the peripheral wires joining with each other. On the other hand, in the vehicle electric wire of various exemplary embodiments of the invention, the diameter of the central wire is set larger than that of the peripheral wires.

Thus in various exemplary embodiments of the invention, the number of the peripheral wires is set to seven or more. The electric conductor having six or fewer peripheral wires has a low tensile strength. The electric conductor of various exemplary embodiments of the invention can be provided with any desired number of peripheral wires not fewer than seven. But in terms of productivity, it is preferable to provide the electric conductor with seven to eleven peripheral wires and more favorable to provide the electric conductor with eight peripheral wires.

The ratio between the diameter of the central wire and that of the peripheral wire is set in such a way that the peripheral wires can be joined with the periphery of the central wire.

Considering that the vehicle electric wire of various exemplary embodiments of the invention is used for the wire harness, its breaking strength is preferably not less than 60 N and more favorably not less than 70 N. The electric wire having a breaking strength in this range sufficiently satisfies a strength required for the electric wire for use in the wire harness of the vehicle in recent years.

The electric wire for use in the wire harness of the vehicle has the standard for the diameter of the electric conductor thereof. Although electric wires having various diameters can be used, an electric conductor having a sectional area of 0.13 mm² to 0.3 mm² can be preferably used. The electric wire whose electric conductor has a diameter in this range is capable of sufficiently meeting requirements of the electric wire for use in the wire harness.

As stainless steel for use in the central wire of the vehicle electric wire of various exemplary embodiments of the invention, various stainless steel can be used. SUS304 and SUS316 having a high tensile strength can be preferably used. The diameter of the central wire is suitably set according to applications and the number of the peripheral wires.

As copper or copper alloy for use in the peripheral wire, various types of copper or copper alloy for use in ordinary electric wires can be used. In consideration of electric conductivity, tensile strength, elongation, and the like of the central wire, copper, Cu—Ag alloy, Cu—Ni—Si alloy, and the like can be preferably used. The diameter of the peripheral wire is set suitably according to use and the number thereof.

An insulating coating is provided on the periphery of the electric conductor before completion of the electric wire. As the insulating coating, known resinous materials can be used, such as polyvinyl chloride (PVC), polyethylene (including expanded material), halogen-free material, tetrafluoroethylene, and the like. The thickness of the insulating coating is set according to a finish outer diameter of the electric conductor.

When a shielding layer is provided on the electric conductor, known various materials having a shielding effect can be used.

Owing to the above-described construction, the tensile strength of the electric conductor can be increased, depending on requirements and adjust the tensile strength to various degrees. By appropriately setting the diameter of the central wire, a material for the central wire, the number of the peripheral wires, the diameter of the peripheral wires, and a material for the peripheral wires, it is possible to provide the electric wire of various exemplary embodiments of the invention whose electric conductor has a diameter (for example, 0.13 mm²) with a tensile strength equal to or higher than that of a conventional electric wire whose electric conductor has a diameter (for example, 0.22 mm²) larger by one rank than that (0.13 mm²) of the electric wire of various exemplary embodiments of the invention.

The method of various exemplary embodiments of the invention of measuring the area ratio of the electric conductor is described below.
(1) Weight (or mass) per unit length (g/m) of central wire (stainless steel) of electric conductor having length of 1 m and weight per unit length (g/m) of all peripheral wires (copper or copper alloy) are measured.
(2) Sectional area of central wire and that of entire peripheral wire are computed from equations shown below:
   Sectional area(mm²)of central wire=Mass(g/m)of central wire÷specific gravity of central wire(g/cm³) I
   Sectional area(mm²)of entire peripheral wire=Mass(g/m)of entire peripheral wire÷specific gravity of peripheral wires(g/cm³) II

(3) Sectional area of electric conductor is computed from equation shown below:
Sectional area(mm²)of electric conductor π×diameter of electric conductor(mm)×π×diameter of electric conductor(mm)÷4 III

(4) Area Ratio={(I÷II)÷III}×100(%)

A method of computing the area ratio of the compressed electric conductor composed of one central wire made of SUS304 and eight peripheral wires, made of copper, which is arranged on the periphery of the central wire is described below.
(1) Weight per unit length of central wire=0.2767 (g/m)
Entire weight of peripheral wire=0.9920 (g/m)
Specific gravity of central wire=7.9 (g/cm³)
Specific gravity of peripheral wire=8.9 (g/cm³)
(2) Therefore, the sectional area of the central wire and the entire sectional area of the peripheral wire are computed as follows:
Sectional area of central wire=3.503×10⁻² (mm²)
Entire sectional area of peripheral wire=111.146×10⁻² (mm²)
(3) Diameter of electric conductor=Ø0.46 (measured value)
Sectional area of electric conductor=15.904×10⁻² (mm²)
(4) Area ratio={(3.503+11.146)÷15.904}×100=92.1(%)

An example of the construction of the electric conductor (compressed electric conductor) of the vehicle electric wire of various exemplary embodiments of the invention is described below. FIG. 5 is a sectional view showing parameters of the construction of the uncompressed vehicle electric wire of various exemplary embodiments of the invention.

Supposing that the diameter of the central wire is y, the diameter of the peripheral wire is d, the number of the peripheral wires is n, the finish outer diameter of the uncompressed electric conductor is D, an angle formed between a line connecting the center of the electric conductor and the center of one peripheral wire to each other and a line connecting the centers of adjacent central wires to each other is θ, the following relationship establishes:
y=(1/cos θ)−1
D=y+2d
θ={(n−2)×180}/2n

Table 1 shows the construction of the electric wire whose electric conductor has an area of 0.13 mm² before the electric conductor is compressed. Table 2 shows the construction of the electric wire after the electric conductor is compressed. The electric conductor of the reference example has six peripheral wires.

TABLE 1

| | | | | | | Reference |
|---|---|---|---|---|---|---|
| | CE1 | CE2 | CE3 | CE4 | CE5 | example |
| Number of | 7 | 8 | 9 | 10 | 11 | 6 |
| peripheral | | | | | | |
| wires | | | | | | |
| Diameter of | 0.155 | 0.140 | 0.130 | 0.120 | 0.110 | 0.175 |
| peripheral | | | | | | |
| wires | | | | | | |
| Diameter of | 0.202 | 0.226 | 0.250 | 0.268 | 0.280 | 0.175 |
| central wire | | | | | | |
| Finish outer | 0.513 | 0.505 | 0.510 | 0.510 | 0.500 | 0.525 |
| diameter | | | | | | |
| θ | 64.29 | 67.50 | 70.00 | 72.00 | 73.64 | 60.00 |
| Radian of θ | 1.12 | 1.18 | 1.22 | 1.26 | 1.29 | 1.05 |
| cosθ | 0.43 | 0.38 | 0.34 | 0.31 | 0.28 | 0.50 |
| Y/d | 1.305 | 1.613 | 1.924 | 2.236 | 2.549 | 1.00 |

where CE in the uppermost column denotes construction example.

TABLE 2

| | | | | | | Reference |
|---|---|---|---|---|---|---|
| | CE1 | CE2 | CE3 | CE4 | CE5 | example |
| Number of | 7 | 8 | 9 | 10 | 11 | 6 |
| peripheral wires | | | | | | |
| Diameter (mm) | 0.45 | 0.45 | 0.45 | 0.45 | 0.45 | 0.45 |
| of compressed | | | | | | |
| Surface ratio of | 0.20 | 0.25 | 0.29 | 0.33 | 0.37 | 0.14 |
| central wire | | | | | | |
| Surface ratio of | 0.80 | 0.75 | 0.71 | 0.67 | 0.63 | 0.86 |
| peripheral wire | | | | | | |

where CE in the uppermost column denotes construction example.

An example of the method of manufacturing the vehicle electric wire of various exemplary embodiments of the invention is described below. The construction of the reference example 1 is as shown in the reference example of table 1. In the reference example 2, the central wire is also made of copper. The area of the electric conductor of the reference example 2 is 0.22 mm² which is larger than that of the reference example 1 by one rank.

### EXAMPLE 1

The central wire used in the example 1 was made of SUS304 having a sectional area which can be computed from the values specified in the construction example 1 of table 1. Each of the peripheral wires used in the example 1 was made of copper and had a sectional area which can be computed from the values specified in the construction example 1 of table 1. Seven peripheral wires were disposed in one layer on the periphery of the central wire with the peripheral wires joining with each other. Thereafter by using a die, the electric conductor having the central wire and the peripheral wires was compressed in the specifications shown in the construction example 1 of table 2.

Thereafter by using a halogen-free material, such as olefin resin, as the coating material, the electric conductor was coated with an insulating coating by, e.g., extrusion to obtain the vehicle electric wire of the example 1 of various exemplary embodiments of the invention. The tensile break strength of the stainless steel wire was 720 MPa. The tensile break strength of each of the copper wires was 230 MPa. The other conditions were as shown in the specifications shown in the construction example 1 of table 1. Table 3 shows the results of the measurement of the outer diameter, weight, and breaking load of the electric wire. The area ratio of the electric conductor was not less than 90%.

### EXAMPLE 2

The central wire used in the example 2 was made of SUS304 having a sectional area which can be computed from the values specified in the construction example 2 of table 1. Each of the peripheral wires used in the example 2 was made of copper and had a sectional area which can be computed from the values specified in the construction example 2 of table 1. Eight peripheral wires were disposed in one layer on the periphery of the central wire with the peripheral wires joining with each other. Thereafter by using a die, the electric conductor having the central wire and the peripheral wires was compressed in the specifications shown in the construction example 2 of table 2.

Thereafter by using a halogen-free material, such as olefin resin, as the coating material, the electric conductor was coated with an insulating coating by, e.g., extrusion to obtain the vehicle electric wire of the example 2 of various exemplary embodiments of the invention. The tensile break strength of the stainless steel wire was 720 MPa. The tensile break strength of each of the copper wires was 230 MPa. The other conditions were as shown in the specifications shown in the construction example 2 of table 1. Table 3 shows the results of measurement of the outer diameter, weight, and breaking load of the electric wire. The area ratio of the electric conductor was not less than 90%.

### REFERENCE EXAMPLE 1

The central wire used in the reference example 1 was made of SUS304 having a sectional area which can be computed from the values specified in the reference example of table 1. Each of the peripheral wires used in the reference example 1 was made of copper and had a sectional area which can be computed from the values specified in the reference example of table 1. Six peripheral wires were disposed in one layer on the periphery of the central wire with the peripheral wires joining with each other. Thereafter by using a die, the electric conductor having the central wire and the peripheral wires was compressed in the specifications shown in the reference example of table 2.

Thereafter by using a halogen-free material, such as olefin resin, as the coating material, the electric conductor was coated with an insulating coating by, e.g., extrusion to obtain the vehicle electric wire of the reference example 1. The tensile break strength of the stainless steel wire was 720 MPa. The tensile break strength of each of the copper wires was 230 MPa. The other conditions were as shown in the specifications shown in the reference example of table 1. Table 3 shows the results of measurement of the outer diameter, weight, and breaking load of the electric wire. The area ratio of the electric conductor was not less than 90%.

### REFERENCE EXAMPLE 2

By using a copper wire for each of the central wires and the peripheral wires, the electric conductor having the central wire and the peripheral wires was compressed with six peripheral wires joining with the periphery of the central wire. Thereafter by using a halogen-free material, such as olefin resin, as the coating material, the electric conductor was coated with an insulating coating by, e.g., extrusion to obtain the vehicle electric wire of the reference example 2. Table 3 shows the results of the measurement of the outer diameter, weight, and breaking load of the electric wire. The area ratio of the electric conductor was not less than 90%.

TABLE 3

| | | | Reference | Reference |
|---|---|---|---|---|
| | Example 1 | Example 2 | example 1 | example 2 |
| Nominal dimension | 0.13 | 0.13 | 0.13 | 0.22 |
| (mm²) | | | | |
| Outer diameter of | 0.85 | 0.85 | 0.85 | 0.95 |
| electric wire (mm) | | | | |
| Weight of electric wire | 1.85 | 1.84 | 1.86 | 2.60 |
| (g/m) | | | | |
| Breaking load (N) | 61 | 65 | 57 | 65 |

Table 3 indicates that the vehicle electric wire of various exemplary embodiments of the invention is superior to that of the reference examples 1 and 2. It is possible to provide the electric wire of the example 2 whose electric conductor had a diameter of 0.13 mm² with the tensile strength equal to that of the electric wire of the reference example 2 in which the central wire and the peripheral wires were made of copper and the electric conductor had a diameter of 0.22 mm² larger by one rank than the diameter 0.13 mm² of the electric conductor of the electric wire of the example 2.

### EXAMPLE 3

The central wire used in the example 3 was made of SUS304 having a sectional area which can be computed from the values specified in the construction example 1 of table 1. Each of the peripheral wires used in the example 3 was made of copper and had a sectional area which can be computed from the values specified in the construction example 1 of table 1. Seven peripheral wires were disposed in one layer on the periphery of the central wire with the peripheral wires joining with each other. Thereafter by using a die, the electric conductor having the central wire and the peripheral wires was compressed in the specifications shown in the construction example 1 of table 2.

Thereafter by using a halogen-free material, such as olefin resin, as the coating material, the electric conductor was coated with an insulating coating by, e.g., extrusion to obtain the vehicle electric wire of the example 3 of various exemplary embodiments of the invention. The tensile break strength of the stainless steel wire was 900 MPa. The tensile break strength of each of the copper wires was 230 MPa. The other conditions were as shown in the specifications shown in the construction example 1 of table 1. Table 4 shows the results of the measurement of the outer diameter, weight, and breaking load of the electric wire. The area ratio of the electric conductor was not less than 90%.

### EXAMPLE 4

The central wire used in the example 4 was made of SUS304 having a sectional area which can be computed from the values specified in the construction example 2 of table 1. Each of the peripheral wires used in the example 4 was made of copper and had a sectional area which can be computed from the values specified in the construction example 2 of table 1. Eight peripheral wires were disposed in one layer on the periphery of the central wire with the peripheral wires joining with each other. Thereafter by using a die, the electric conductor having the central wire and the peripheral wires was compressed in the specifications shown in the construction example 2 of table 2.

Thereafter by using a halogen-free material, such as olefin resin, as the coating material, the electric conductor was coated with an insulating coating by, e.g., extrusion to obtain the vehicle electric wire of the example 4 of various exemplary embodiments of the invention. The tensile break strength of the stainless steel wire was 900 MPa. The tensile break strength of each of the copper wires was 230 MPa. The other conditions were as shown in the specifications shown in the construction example 2 of table 1. Table 4 shows the results of the measurement of the outer diameter, weight, and breaking load of the electric wire. The area ratio of the electric conductor was not less than 90%.

### REFERENCE EXAMPLE 3

The central wire used in the reference example 3 was made of SUS304 having a sectional area which can be computed from the values specified in the reference example of table 1. Each of the peripheral wires used in the reference example 3 was made of copper and had a sectional area which can be computed from the values specified in the reference example of table 1. Six peripheral wires were disposed in one layer on the periphery of the central wire with the peripheral wires joining with each other. Thereafter by using a die, the electric conductor having the central wire and the peripheral wires was compressed in the specifications shown in the reference example of table 2.

Thereafter by using a halogen-free material, such as olefin resin, as the coating material, the electric conductor was coated with an insulating coating by, e.g., extrusion to obtain the vehicle electric wire of the reference example 3. The tensile break strength of the stainless steel wire was 900 MPa. The tensile break strength of each of the copper wires was 230 MPa. The other conditions were as shown in the specifications shown in the reference example of table 1. Table 4 shows the results of measurement of the outer diameter, weight, and breaking load of the electric wire. The area ratio of the electric conductor was not less than 90%.

TABLE 4

| | | | Reference | Reference |
|---|---|---|---|---|
| | Example 3 | Example 4 | example 3 | example 2 |
| Nominal | 0.13 | 0.13 | 0.13 | 0.22 |
| dimension(mm²) | | | | |
| Outer diameter of | 0.85 | 0.85 | 0.85 | 0.95 |
| electric wire(mm) | | | | |
| Weight of electric | 1.85 | 1.84 | 1.86 | 2.60 |
| wire(g/m) | | | | |
| Breaking load(N) | 66 | 71 | 61 | 65 |

Table 4 indicates that the vehicle electric wire of various exemplary embodiments of the invention is superior to that of the reference example. The electric wire of the example 3 can be provided with a tensile strength almost equal to that of the electric wire of the reference example in which the central wire and the peripheral wires were made of copper and the electric conductor had a diameter larger by one rank than the diameter of the electric conductor of the electric wire of the example 3. Table 4 also indicates that the vehicle electric wire of the example 4 had a higher tensile strength than the vehicle electric wire of the example 3.

While the invention has been particularly described, in conjunction with specific preferred embodiments, it is evident that many alternatives, modifications, and variations will be apparent to those skilled in the art of the foregoing description. It is therefore contemplated that the appended claims will embrace any such alternatives, modifications, and variations as falling within the true scope and spirit of the invention.

1. An electric wire for a vehicle comprising:
an electric conductor including:
a single central wire made of stainless steel, and
seven or more peripheral wires made of copper or copper alloy, which are disposed in one layer on a periphery of the central wire with the peripheral wires joining with each other such that the peripheral wires surround the central wire,
wherein a diameter of the central wire is set larger than that of the peripheral wires; and
an area ratio of the electric conductor satisfies area ratio of electric conductor={(A+B)/C}×100(%)≧85(%),
where A denotes a total of sectional areas of the peripheral wires, B denotes a sectional area of the central wire, and C is a sectional area of the electric conductor.

2. The electric wire for a vehicle according to claim 1, wherein the area ratio of the electric conductor is not less than 90%.

3. The electric wire for a vehicle according to claim 1, wherein the sectional area of the central wire is set to not less than 19.5% of the sectional area of the electric conductor.

4. The electric wire for a vehicle according to claim 1, wherein the sectional area of the electric conductor is set to not more than 0.3 mm².

5. The electric wire for a vehicle according to claim 1, wherein the electric conductor is compressed.

6. The electric wire for a vehicle according to claim 1, wherein the electric conductor has a stranded construction.

7. The electric wire for a vehicle according to claim 2, wherein the sectional area of the central wire is set to not less than 19.5% of the sectional area of the electric conductor.

8. The electric wire for a vehicle according to claim 2, wherein the sectional area of the electric conductor is set to not more than 0.3 mm².

9. The electric wire for a vehicle according to claim 2, wherein the electric conductor is compressed.

10. The electric wire for a vehicle according to claim 2, wherein the electric conductor has a stranded construction.

11. The electric wire for a vehicle according to claim 3, wherein the sectional area of the electric conductor is set to not more than 0.3 mm².

12. The electric wire for a vehicle according to claim 3, wherein the electric conductor is compressed.

13. The electric wire for a vehicle according to claim 3, wherein the electric conductor has a stranded construction.

14. The electric wire for a vehicle according to claim 4, wherein the electric conductor is compressed.

15. The electric wire for a vehicle according to claim 4, wherein the electric conductor has a stranded construction.

16. The electric wire for a vehicle according to claim 5, wherein the electric conductor has a stranded construction.
